(19) United States
(12) Patent Application Publication
(10) Pub. No.: US 2015/0205688 A1
(43) Pub. Date: Jul. 23, 2015

(54) Method for Migrating Memory and Checkpoints in a Fault Tolerant System

(71) Applicant: Stratus Technologies Bermuda Ltd., Hamilton (BM)

(72) Inventors: Steven Haid, Bolton, MA (US); Kimball A. Murray, Shirley, MA (US); Robert J. Manchek, Waltham, MA (US)

(21) Appl. No.: 14/571,405

(22) Filed: Dec. 16, 2014

Related U.S. Application Data
(60) Provisional application No. 61/921,724, filed on Dec. 30, 2013.

(51) Int. Cl. G06F 11/20; G06F 11/14

(52) U.S. Cl. CPC G06F 11/2082; G06F 11/1438; G06F 11/1451; G06F 11/1484; G06F 2201/84; G06F 2201/815

(57) ABSTRACT

A method of migrating memory from a primary computer to a secondary computer. In one embodiment, the method includes the steps of: (a) waiting for a checkpoint on the primary computer; (b) pausing the primary computer; (c) selecting a group of pages of memory to be transferred to the secondary computer; (d) transferring the selected group of pages of memory and checkpointed data; (e) restarting the primary computer; (f) waiting for a checkpoint on the primary computer; (g) pausing the primary computer; (h) selecting another group of pages of memory to be transferred; (i) transferring the other selected group of pages of memory and data checkpointed since the previous checkpoint to the secondary computer; (j) restarting the primary computer; and (k) repeating steps (f) through (j) until all the memory of the primary computer is transferred.

### RELATED APPLICATIONS

This application claims priority to U.S. provisional patent application 61/921,724 filed on Dec. 30, 2013 and owned by the assignee of the current application, the contents of which are herein incorporated by reference in their entirety.

### FIELD OF THE INVENTION

The invention relates generally to the field of fault tolerant computing and more specifically to synchronizing a fault tolerant system.

### BACKGROUND OF THE INVENTION

There are a variety of ways to achieve fault tolerant computing. Specifically, fault tolerant hardware and software may be used either alone or together. As an example, it is possible to connect two (or more) computers, such that one computer, the active or host computer, actively makes calculations while the other computer (or computers) is idle or on standby in case the active computer, or hardware or software component thereon, experiences some type of failure. In these systems, the information about the final state of the active computer must be periodically saved to the standby computer so that the standby computer can substantially take over computation at the point in the calculations where the active computer experienced a failure. This example can be extended to the modern day practice of using a virtualized environment as part of a cloud or other computing system.

Virtualization is used in many fields to reduce the number of servers or other resources needed for a particular project or organization. Present day virtual machine computer systems utilize virtual machines (VM) operating as guests within a physical host computer. Each virtual machine includes its own virtual operating system and operates under the control of a managing operating system, termed a hypervisor, executing on the host physical machine. Each virtual machine executes one or more applications and accesses physical data storage and computer networks as required by the applications. In addition, each virtual machine may in turn act as the host computer system for another virtual machine.

Multiple virtual machines may be configured as a group to execute one or more of the same programs. Typically, one virtual machine in the group is the primary or active virtual machine, and the remaining virtual machines are the secondary or standby virtual machines. If something goes wrong with the primary virtual machine, one of the secondary virtual machines can take over and assume its role in the fault tolerant computing system. This redundancy allows the group of virtual machines to operate as a fault tolerant computing system. The primary virtual machine executes applications, receives and sends network data, and reads and writes to data storage while performing automated or user-initiated tasks or interactions. The secondary virtual machines have the same capabilities as the primary virtual machine, but do not take over the relevant tasks and activities until the primary virtual machine fails or is affected by an error.

For such a collection of virtual machines to function as a fault tolerant system, the operating state, memory, and data storage contents of a secondary virtual machine should be equivalent to the final operating state, memory, and data storage contents of the primary virtual machine. If this condition is met, the secondary virtual machine may take over for the primary virtual machine without a loss of any data. To assure that the state of the secondary machine and its memory is equivalent to the state of the primary machine and its memory, it is necessary for the primary virtual machine periodically to transfer its state and memory contents to the secondary virtual machine.

The periodic transfer of data to maintain synchrony between the states of the virtual machines is termed checkpointing. A checkpoint defines a point in time when the data is to be transferred. When a checkpoint is declared to have occurred is determined by a checkpoint controller, which is typically a software module. During a checkpoint, the processing on the primary virtual machine is paused, so that the final state of the virtual machine and associated memory is not changed during the checkpoint interval and once the relevant data is transferred, both the primary and secondary virtual machines are in the same state. The primary virtual machine is then resumed and continues to run the application until the next checkpoint, when the process repeats.

Checkpoints can be determined either by the checkpoint controller to occur by the passage of a fixed amount of elapsed time from the last checkpoint, or by the occurrence of some event, such as the number of memory accesses (termed dirty pages), the occurrence of a network event (such as network acknowledgement output from the primary virtual machine), or the occurrence of excessive buffering on the secondary virtual machine (as compared to available memory) during the execution of the application. Elapsed time checkpointing is considered fixed checkpointing, while event based checkpointing is considered dynamic or variable-rate checkpointing.

The process of checkpointing generally involves identifying the differences between the operational state of a primary system and a secondary system, and sending updates of those differences to the secondary system when the primary system changes. In this way, the two systems operate in a fault tolerant manner, with the secondary system available if the first system fails or experiences a significant error. However, in order to checkpoint two systems by sending the differences that occur over time, the two systems need to be synchronized such that checkpointing can occur following synchronization. Synchronizing virtual systems is challenging and there is a need to reduce the performance degradation that synchronizing causes in the active system being synchronized with a standby system. Further, reducing and/or bounding the amount of time the primary system is paused to avoid excessive system blackout times, which may lead to network issues between the primary system and remote clients, is also challenging.

The present invention addresses these challenges.

### SUMMARY OF THE INVENTION

In one aspect, the invention relates to a method of migrating memory from a primary computer to a secondary computer. In one embodiment, the method includes the steps of: (a) waiting for a checkpoint on the primary computer; (b) pausing the primary computer; (c) selecting a group of pages of memory to be transferred to the secondary computer; (d) transferring the selected group of pages of memory and checkpointed data to the secondary computer; (e) restarting the primary computer; (f) waiting for a checkpoint on the primary computer; (g) pausing the primary computer; (h) selecting another group of pages of memory to be transferred to the secondary computer; (i) transferring the other selected group of pages of memory and data that has been checkpointed since the previous checkpoint to the secondary computer; (j) restarting the primary computer; and (k) repeating steps (f) through (j) until all the memory of the primary computer is transferred.

In another embodiment, the checkpointed data that is transferred to the secondary computer since the previous checkpoint is only checkpointed data from a previously transferred group of pages of memory. In yet another embodiment, the number of pages in a groups of pages of memory transferred at each checkpoint varies. In still yet another embodiment, in addition to the selected group of pages of memory and checkpointed data being transferred, a predetermined number of additional pages are also transferred.

In another embodiment, the predetermined number of pages of memory are marked as dirty pages whether the pages have been accessed or not. In yet another embodiment, the selected group of pages is selected from a pool of pages. In still yet another embodiment, the pages are selected from a pool that is determined by a sweep index. In another embodiment, the sweep index ranges from 0 to the highest page number of memory.

In another aspect, the invention relates to a computer system including a primary computer having a primary computer memory and a primary computer checkpoint controller, a secondary computer having a secondary computer memory, and a communications link between the primary computer and the secondary computer. In one embodiment, the checkpoint controller of the primary computer declares a checkpoint, the primary computer is paused, a group of pages of memory of the primary computer is selected to be transferred to the secondary computer, the selected group of pages of memory and checkpointed data is transferred to the secondary computer over the communications link, and the primary computer is restarted, and when another checkpoint is declared by the primary computer checkpoint controller, another group of pages of memory to be transferred to the secondary computer is selected, and the other selected group of pages of memory and any data checkpointed since the previous checkpoint is transferred to the secondary computer. In another embodiment, the pages selected for transfer are determined by a sweep index counter.

### BRIEF DESCRIPTION OF THE DRAWINGS

The structure and function of the invention can be best understood from the description herein in conjunction with the accompanying figures. The figures are not necessarily to scale, emphasis instead generally being placed upon illustrative principles. The figures are to be considered illustrative in all aspects and are not intended to limit the invention, the scope of which is defined only by the claims.

FIG. 1 is a block diagram of a method of migrating virtual machines from a primary virtual machine to a secondary virtual machine according to the prior art.

FIGS. 2(a) and (b) are block diagrams of an embodiment of the steps of a method of migrating memory and checkpoint data from a primary virtual machine to a secondary virtual machine so as to synchronize the systems.

FIG. 3 is a flow chart of an algorithm that implements an embodiment of the invention.

### DESCRIPTION OF A PREFERRED EMBODIMENT

Detailed embodiments of the invention are disclosed herein, however, it is to be understood that the disclosed embodiments are merely exemplary of the invention, which may be embodied in various forms. Therefore, specific functional details disclosed herein are not to be interpreted as limiting, but merely as a basis for the claims and as a representative basis for teaching one skilled in the art to variously employ the invention in virtually any appropriately detailed embodiment.

Prior to creating a fault tolerant system using two or more virtual machines on different computing devices, the virtual machines need to be synchronized. Thus, synchronization is a predicate to checkpointing. The technique of live migration of virtual machines can be used to perform such synchronization as described herein.

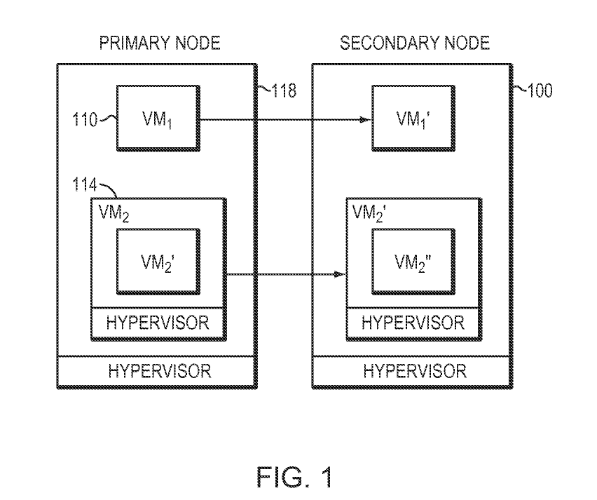

There is a challenge using a live migration technique for synchronization as shown in FIG. 1. When a secondary virtual machine is first brought into the system to act as backup for the primary virtual machine, it is necessary to move the entire present state of the memory of the primary virtual machine to the secondary machine as well as any dirty pages that occur during the copying of the memory from the primary to secondary machine. One issue is that a single move of all of memory is not sufficiently defined so as to assure that a user will not be blocked from using the computer for an amount of time that is bounded.

When a new secondary node 100 joins a fault tolerant system, the virtual machines 110, 114 of the primary node 118 must be copied or replicated to the secondary node 100 over a communications link. Virtual machines and virtual machines operating within virtual machines are transferred all at once from the primary node 118 or host to the secondary node 100. In the methods known to the prior art, a virtual machine to be copied is paused and the memory of the virtual machine is copied while the virtual machine is paused, thereby preventing the additional dirtying of memory pages. When the copying of the memory is completed, the primary virtual machine is restarted. Migration, as is known in the prior art, can be performed in two phases: a background (or brownout) phase and foreground (or blackout) phase. Only in the foreground phase (or the final phase) will the virtual machine be paused. In general, live migration known to the prior art cannot guarantee that both phases are sufficiently bounded in time. In contrast, embodiments of the present invention allow for a bounded synchronization approach.

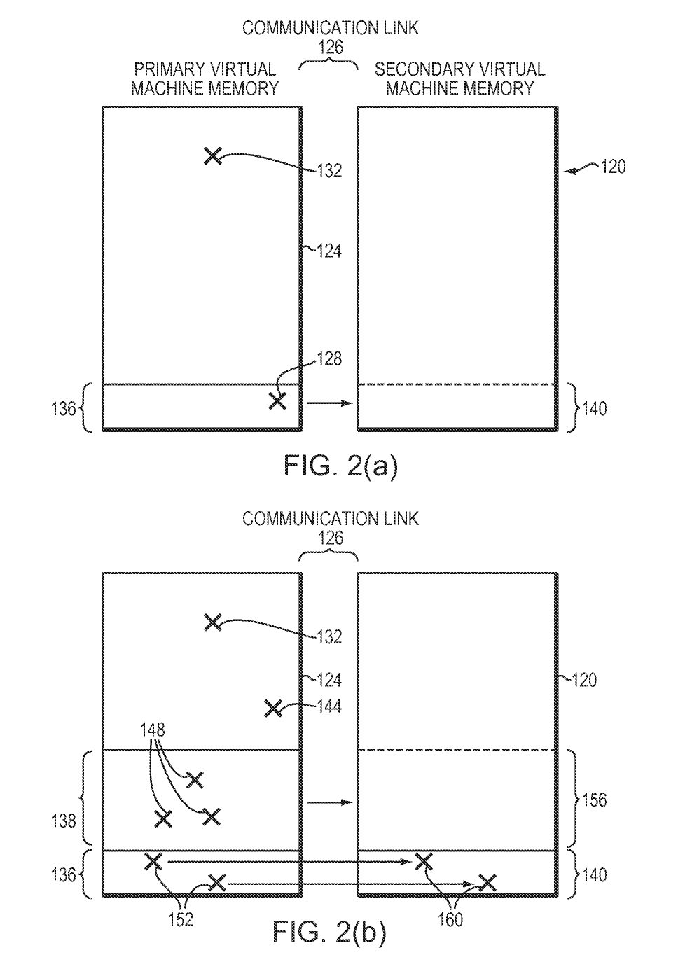

Referring to FIG. 2(a), when a secondary virtual machine is brought into a redundant system, its memory 120 must be brought into conformance with the memory 124 of the primary virtual machine. The primary virtual machine memory 124 includes pages which are not currently dirty as well as dirty pages 128, 132. Upon a checkpoint event on the primary virtual machine, the copying of the memory 124 of the primary virtual machine to the memory 120 of the secondary virtual machine is initiated over a communications link 126.

The copying begins with pausing of the primary virtual machine and the copying of a first group of pages or segment of memory 136, which may include checkpoint data 128, to a first group of pages or segment 140 in the memory 120 of the secondary virtual machine. Any checkpoint data in the primary virtual machine segment 136 is naturally copied along with the segment 136. In one embodiment, checkpoint data 132 in the primary virtual machine memory 124 that is above the memory segment 136 currently being copied, are not copied. This is because all the portions of memory above the memory segment currently being copied will be copied in a subsequently-copied memory segment. The primary virtual machine is then restarted.

As the primary virtual machine runs, additional pages are dirtied, including pages of the memory previously copied. Referring to FIG. 2(b), upon the next checkpoint event, the primary virtual machine is paused and a next group of pages 138 of the memory 124 of the primary virtual machine, which may include additional dirty pages 144, 148 and 152, is copied to the next group of pages 156 of memory 120 of the secondary virtual machine. Because the entire group of pages 138 is copied, the recently dirtied pages 148 in the group 138 are also automatically copied. In addition, newly dirtied pages 152 in any group of pages previously copied 136 are also copied 160 to the previously copied pages 140. Again, in one embodiment, any pages that are dirty 132, 144 in any portion of memory above the group of pages currently being copied 138 are not copied.

This process is iteratively continued until all of the pages of memory 124 of the primary virtual machine have been copied. At this time, the memory of the primary virtual machine and the memory of the secondary virtual machine are identical. This synchronization of the two VMs allows checkpointing to be performed only with respect to differences from this synchronized state. Accordingly, subsequent changes to the memory of the primary virtual machine are then copied to the memory of the secondary virtual machine using the standard checkpointing techniques.

Although the groups of pages 136, 138 are shown as consecutive, they need not be as long as all of memory is transferred. Further, the groups of pages need not be of the same size. Finally, it is not a requirement that only the checkpoint data in previously copied pages be transferred during subsequent checkpoints. All new checkpoint data may be copied regardless of whether those pages have been copied before. Thus, in FIG. 2(a), dirty page 132 could also be copied along with the group of pages 136.

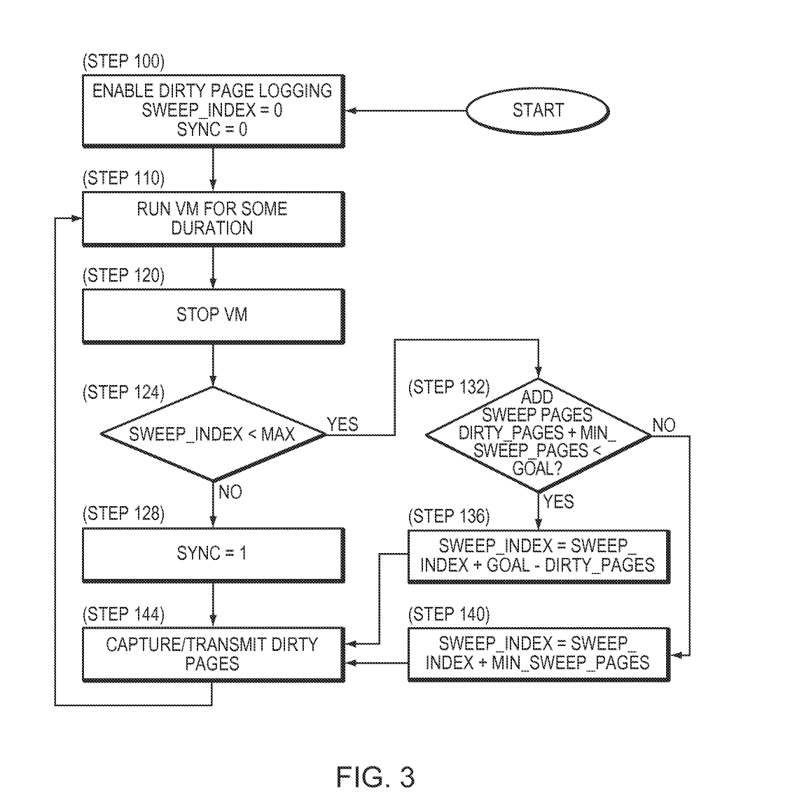

Referring to FIG. 3, an algorithm is depicted which implements an embodiment of the invention. As part of the operation of the algorithm, at a high level, the checkpoint engine is run as if the primary VM and secondary VM or VMs are already in sync. In addition to processing pages dirtied by the primary VM in each checkpoint cycle, this system is configured to indicate some set of additional pages were dirtied, whether this was true or not. These additional pages, also referred to as MIN_SWEEP_PAGES, originate from a sweep pool which initially is comprised of all VM memory pages. A parameter referred to as the SWEEP_INDEX controls which pages are drawn from the pool. The slowest rate for synchronizing a primary and a secondary VM occurs when only the MIN_SWEEP_PAGES are used to migrate the memory of the primary VM to the secondary VM. In contrast, the fastest rate for synchronizing a primary and a secondary VM occurs when the primary VM is idle or inactive, such that all of the data transferred for each cycle is used to update the memory of the secondary VM.

Initially, the SWEEP_INDEX starts at 0 and increases toward the highest page in VM memory. In each checkpoint cycle, some number of pages are drawn from the sweep pool and added to the existing list of dirty pages already found by the checkpoint processing. In one embodiment, for each cycle, at least MIN_SWEEP_PAGES are added to the existing payload of dirty pages. The checkpoint engine can bound the total number of dirty pages in a cycle (by varying cycle length and/or throttling the VM's ability to modify pages). As a result, the additional MIN_SWEEP_PAGES still result in a bounded number of pages to send in for each checkpoint.

The bounded number of pages found in each checkpoint guarantees an upper bound for checkpoint blackout times for the running source VM. By always adding at least MIN_SWEEP PAGES to the SWEEP_INDEX, each checkpoint cycle guarantees that the sweep will complete in a finite time period. These features of using a bounded number of pages and adding pages to the SWEEP_INDEX on a per-checkpoint-cycle basis address the deficiencies of live migration.

In this embodiment, the number of pages in the memory is defined as MAX and the number of pages currently copied is defined as SWEEP_INDEX. When all the memory has been transferred, such that the primary VM and secondary VM are synchronized, a synchronized flag SYNC is set to 1. Checkpointing the changes between the primary VM and secondary VM can occur once synchronization through a modified live migration technique is used as described herein. In one embodiment, pages of memory are transmitted at a rate of 10,000 for 50 milliseconds to synchronize the primary VM and the secondary VM. In one embodiment, pages of memory are transmitted at a rate of 8,000 for 50 milliseconds to synchronize the primary VM and the secondary VM. In one embodiment, pages of memory are transmitted at a rate of from about 5,000 for 50 milliseconds to about 18,000 for 50 milliseconds to synchronize the primary VM and the secondary VM.

The synchronization algorithm begins with the SWEEP_INDEX and the SYNC flag being set to 0 (Step 100) while starting to log dirty pages in the primary VM. The SYNC flag being set to 0 indicates the primary VM and secondary VM are not in sync. The primary virtual machine is allowed to run (Step 110) for a period of time or a number of pages and to generate a checkpoint event. In one embodiment, the primary VM is stopped after about 50 pages are dirtied. Upon the generating of a checkpoint event, the primary virtual machine is paused (Step 120) and the sweep page counter SWEEP_INDEX is compared to the maximum number of pages in memory (Step 124). If the SWEEP_INDEX is not less than MAX, then the SYNC flag is set to 1 which indicates the primary and secondary machine are synchronized.

If the SWEEP_INDEX is less than MAX, then the two VMs are not yet synchronized. As a result, the current number of pages to be transferred is added to the additional number of dirty pages to be transferred and the result added to the minimum number of pages to be transferred (MIN_SWEEP_PAGES), and this result compared to a goal amount (GOAL). In one embodiment, the GOAL is between about 50 pages to about 200 pages. In one embodiment, the GOAL is between about 75 pages to about 150 pages. In one embodiment, the GOAL is about 100 pages.

If the result is not less than GOAL amount, the new SWEEP_INDEX is set to the previous SWEEP_INDEX plus the MIN_SWEEP_{—} PAGES (Step 140). At this point, the dirty pages are transferred (Step 144) and the virtual machine is restarted (Step 110). If the result is less than the GOAL amount, the new SWEEP_INDEX is set to the previous SWEEP_INDEX plus the GOAL amount minus the number of DIRTY_PAGES to be transferred Step (136). This Step (136) addresses the common case where SWEEP pages are being added to the list of dirty pages. That is, on every cycle the synchronization method will include at least MIN_SWEEP_PAGES in the transfer, but the expectation is that more than the MIN_SWEEP_PAGES will be added. In the common case, the dirty page count is so far below GOAL that all the remaining space (GOAL—DIRTY) can be filled with SWEEP pages. In the less common (busier) case, the dirty page count is so large that only adding MIN_SWEEP_PAGES to the list of dirty pages is advisable. At this point, the dirty pages are again transferred (Step 144) and the virtual machine is restarted (Step 110).

Thus, the present invention provides a way of transferring data from an active memory to a secondary system while maintaining a bounded time for the transfer. This allows a primary VM and a secondary VM to be synchronized prior to engaging checkpointing of the differences between the VMs.

Unless specifically stated otherwise as apparent from the following discussion, it is appreciated that throughout the description, discussions utilizing terms such as “processing” or “computing” or “calculating” or “delaying” or “comparing”, “generating” or “determining” or “committing” or “checkpointing” or “interrupting” or “handling” or “receiving” or “buffering” or “allocating” or “displaying” or “flagging” or Boolean logic or other set related operations or the like, refer to the action and processes of a computer system, or electronic device, that manipulates and transforms data represented as physical (electronic) quantities within the computer system's or electronic devices' registers and memories into other data similarly represented as physical quantities within electronic memories or registers or other such information storage, transmission or display devices.

The algorithms presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description above. In addition, the present invention is not described with reference to any particular programming language, and various embodiments may thus be implemented using a variety of programming languages.

The aspects, embodiments, features, and examples of the invention are to be considered illustrative in all respects and are not intended to limit the invention, the scope of which is defined only by the claims. Other embodiments, modifications, and usages will be apparent to those skilled in the art without departing from the spirit and scope of the claimed invention.

In the application, where an element or component is said to be included in and/or selected from a list of recited elements or components, it should be understood that the element or component can be any one of the recited elements or components and can be selected from a group consisting of two or more of the recited elements or components. Further, it should be understood that elements and/or features of a composition, an apparatus, or a method described herein can be combined in a variety of ways without departing from the spirit and scope of the present teachings, whether explicit or implicit herein.

The use of the terms “include,” “includes,” “including,” “have,” “has,” or “having” should be generally understood as open-ended and non-limiting unless specifically stated otherwise.

It should be understood that the order of steps or order for performing certain actions is immaterial so long as the present teachings remain operable. Moreover, two or more steps or actions may be conducted simultaneously.

It is to be understood that the figures and descriptions of the invention have been simplified to illustrate elements that are relevant for a clear understanding of the invention, while eliminating, for purposes of clarity, other elements. Those of ordinary skill in the art will recognize, however, that these and other elements may be desirable. However, because such elements are well known in the art, and because they do not facilitate a better understanding of the invention, a discussion of such elements is not provided herein. It should be appreciated that the figures are presented for illustrative purposes and not as construction drawings. Omitted details and modifications or alternative embodiments are within the purview of persons of ordinary skill in the art.

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes which come within the meaning and range of equivalency of the claims are intended to be embraced therein.

What is claimed is:

1. A method of migrating memory from a primary computer to a secondary computer comprising the steps of:
a) waiting for a checkpoint on the primary computer;
b) pausing the primary computer;
c) selecting a group of pages of memory to be transferred to the secondary computer;
d) transferring the selected group of pages of memory and checkpointed data to the secondary computer;
e) restarting the primary computer;
f) waiting for a checkpoint on the primary computer;
g) pausing the primary computer;
h) selecting another group of pages of memory to be transferred to the secondary computer;
i) transferring, to the secondary computer, the other selected group of pages of memory and any data checkpointed since the previous checkpoint;
j) restarting the primary computer; and
k) repeating steps (f) through (j) until all the memory of the primary computer is transferred.

2. The method of claim 1 wherein the checkpointed data that is transferred to the secondary computer since the previous checkpoint is only checkpointed data from a previously transferred group of pages of memory.

3. The method of claim 1 wherein the number of pages in a group of pages of memory transferred at each checkpoint varies.

4. The method of claim 1 wherein in addition to the selected group of pages of memory and checkpointed data being transferred, a predetermined number of additional pages is also transferred.

5. The method of claim 4 wherein the predetermined number of pages of memory are marked as dirty pages whether the pages have been accessed or not.

6. The method of claim 4 wherein the selected group of pages are selected from a pool of pages.

7. The method of claim 6 wherein a sweep index determines which pages are selected from a pool.

8. The method of claim 7 wherein the sweep index ranges from 0 to the highest page number of memory.

9. A computer system comprising:
a primary computer having a primary computer memory and a primary computer checkpoint controller;
a secondary computer having a secondary computer memory; and
a communications link between the primary computer and the secondary computer;
wherein when the checkpoint controller of the primary computer declares a checkpoint, the primary computer is paused, a group of pages of memory of the primary computer is selected to be transferred to the secondary computer, the selected group of pages of memory and checkpointed data is transferred to the secondary computer over the communications link, and the primary computer is restarted; and
wherein when another checkpoint is declared by the primary computer checkpoint controller, another group of pages of memory to be transferred to the secondary computer is selected, and the other selected group of pages of memory and any data checkpointed since the previous checkpoint is transferred to the secondary computer.

10. The computer system of claim 9 wherein the pages selected for transfer are determined by a sweep index counter.
